(19) United States
(12) Patent Application Publication
(10) Pub. No.: US 2026/0322027 A1
(43) Pub. Date: Oct. 15, 2026

(54) WIRE COVER AND OPERATING METHOD THEREOF

(71) Applicant: HL MANDO CORPORATION, Pyeongtaek-si (KR)

(72) Inventors: Jaehyeong CHO, Pyeongtaek-si (KR); Joonho JUNG, Pyeongtaek-si (KR)

(73) Assignee: HL MANDO CORPORATION, Pyeongtaek-si, Gyeonggi-do (KR)

(21) Appl. No.: 19/311,260

(22) Filed: Aug. 27, 2025

(30) Foreign Application Priority Data
Apr. 9, 2025 (KR) 10-2025-0045955

(51) Int. Cl. H01R 13/516

(52) U.S. Cl. CPC H01R 13/516; H01R 2201/26

(57) ABSTRACT

A wire cover and an operating method of the same are disclosed. The wire cover includes a mounting portion configured to be coupled to a connector connected to an electrical component, and a guide portion that surrounds a wire connected to the electrical component via the connector. The guide portion extends in a longitudinal direction from the mounting portion. The mounting/guide portions are integrally formed or formed of the same material. The guide portion is configured with a smaller thickness than the mounting portion, enabling it to be deformable and to maintain its shape according to a wiring guide path that avoids contact with surrounding components. The structure facilitates flexible routing and stable support of the wire in various installation environments. The operating method includes receiving the wire and connector, closing the cover, and deforming the guide portion along a desired path, which in embodiments improves installation efficiency and reliability.

### CROSS-REFERENCE TO RELATED APPLICATIONS

This application claims the priority to Korean Patent Application No. 10-2025-0045955 filed on Apr. 9, 2025, in the Korean Intellectual Property Office, the disclosure of which is incorporated herein by reference in its entirety.

### BACKGROUND

### Technical Field

The present disclosure relates to a wire cover and an operating method thereof, and more particularly, to a wire cover and an operating method thereof capable of stably supporting and connecting a wire along a wiring path, regardless of various shapes or sizes of an installation space.

### Description of the Related Art

Various types of electric components are installed and used in vehicles and other devices, and such electric components are electrically connected via wires. Generally, a connector for electrical connection with a power supply device or control device such as a vehicle battery is provided at one end of the wire, and an electric component that transmits power or an electrical signal is connected at the other end via the connector or is directly electrically connected to the wire.

Nowadays, numerous electric components that implement various functions are applied to vehicles, and accordingly, the wire routing work that implements power supply and electrical communication for the electric components has become a very important manufacturing process that determines the performance and reliability of the vehicle.

In addition, as numerous electric components are applied to vehicles, the number of installed wires and the installation space are also increasing. In this case, if the routed wire comes into contact with or interferes with surrounding components or structures, it may adversely affect not only the wire but also the performance, stability, and durability of the surrounding components or structures.

Accordingly, in the related art, after estimating in advance the wire routing path that can avoid surrounding components or structures, various types of wire support devices are separately designed and manufactured in accordance with the angle or curvature of the routing path, and are used for wiring work. As a result, not only do the labor and working time required for the wire routing work increase rapidly, but also cover members of various forms must be individually designed and manufactured, causing problems such as material waste and increased cost.

### BRIEF SUMMARY

The present disclosure addresses the need for a solution capable of supporting and connecting multiple wires stably within an installation space or along a routing path, while avoiding interference with surrounding components. In addition, the disclosed approach improves the efficiency of wiring operations and reduces manufacturing and labor costs.

To this end, the present disclosure describes a wire cover including a mounting member (also referred to as ‘a mounting portion’) and a guide member (also referred to as ‘a guide portion’), both formed from the same material such as polyamide but with different thicknesses to provide distinct structural characteristics suited to their respective functions. The mounting portion is configured with greater thickness to provide rigidity and secure engagement with a connector, while the guide portion has a reduced thickness that allows it to deform and retain its shape to accommodate various wire routing paths. The guide portion further incorporates a corrugated structure that enables directional bending while maintaining protection of the wire. This arrangement allows a single component to accommodate a range of installation geometries without the need for custom designs.

A two-part construction is described, comprising of a first body and a second body that are either rotatably connected or separable along the direction of the wire. This configuration allows for lateral insertion of the wire and connector, which simplifies the installation process in constrained environments. The two bodies are joined using a fastening mechanism that includes projections and tabs, and additional features such as a taper portion and a support portion with a protruding element that serve to reduce interference with nearby components and maintain the configured wire path.

A method of use includes steps for opening the cover, inserting the wire and connector, securing the two bodies together, and manually shaping the guide portion to follow a desired routing path that avoids contact with surrounding elements. This approach enables flexible adaptation during installation while maintaining structural integrity and protective function. In various implementations, the described features reduce manufacturing complexity, improve ease of assembly, and enhance the spatial efficiency and reliability of wire routing in vehicle and equipment applications.

Various embodiments of the present disclosure are directed to a wire cover and an operation method thereof, capable of stably supporting and connecting a wire while avoiding surrounding components or structures in the installation space.

Various embodiments of the present disclosure provide a wire cover and an operation method thereof, capable of easily and quickly routing a wire regardless of various angles and shapes of the routing path.

Various embodiments of the present disclosure provide a wire cover and an operation method thereof, which has a simple structure and is smoothly applicable and compatible with various angles and shapes of routing paths.

Various embodiments of the present disclosure provide a wire cover and an operation method thereof, capable of improving the efficiency of wiring work and reducing manufacturing and working costs.

Various embodiments of the present disclosure provide a wire cover and an operating method thereof that can enhance the performance and durability of the wire, the electric component, and surrounding component elements.

Various embodiments of the present disclosure provide a wire cover and an operating method thereof that can improve the spatial utilization of a vehicle body or panel.

According to one aspect of the disclosure, there is provided a wire cover comprising: a mounting part configured to be coupled to a connector connected to an electric component; and a guide part configured to surround a wire electrically connected to the electric component via the connector and to extend from the mounting part along a longitudinal direction of the wire, wherein the mounting part and the guide part are integrally formed or formed of the same material, and wherein the guide part is deformable and maintainable corresponding to a wiring guide path of the wire, and a thickness of the guide part is relatively smaller than a thickness of the mounting part.

The guide part may have a hollow shape and may include a corrugation tube in which a plurality of corrugations are formed along a longitudinal direction.

The guide part may be formed of a polyamide material, and a thickness of the guide part or a thickness of the corrugation tube may be in a range of about 0.6 T to 0.9 T.

A support part provided at an outer end of the guide part may further be included.

A thickness of the support part may be greater than a thickness of the guide part.

The support part may include a support protrusion configured to support the guide part on an adjacent component element or a neighboring separate wire cover.

The mounting part and the guide part may be separable and joinable in a direction parallel to a longitudinal direction of the wire, respectively.

At least one of the guide part on the first body and the guide part on the second body may include a wire accommodation space on an inner side and an entrance formed open on one side to allow the wire to enter the wire accommodation space, and the first body and the second body may be coupled to close the wire accommodation space and the entrance.

A locking projection provided on one of the first body and the second body, and a locking tab provided on the other of the first body and the second body and configured to engage with the locking projection may further be included.

The second body may be rotatably provided with respect to the first body via a hinge shaft.

An arrangement direction of the hinge shaft may be provided to be parallel to a longitudinal direction of the wire.

The mounting part, the guide part, and the support part may be integrally formed.

At least one of the mounting part on the first body and the mounting part on the second body may further include a connector accommodation space configured to receive at least a portion of the connector, and the first body and the second body may be coupled to close the connector accommodation space and the entrance.

At least one locking rib provided on an inner surface of the mounting part and configured to engage with the connector may further be included, and the locking rib may be arranged in plurality along a longitudinal direction of the wire.

An operating method of a wire cover according to the present disclosure may include: separating or spacing a second body from a first body in a wire cover comprising the first body and the second body to open an entrance formed in the first body; accommodating a wire in a wire accommodation space of the first body through the entrance; coupling the second body to the first body to enclose the wire and close the entrance; and deforming a guide part, which is formed to extend along a longitudinal direction of the wire and has a thickness relatively smaller than other portions of the wire cover so as to be deformable, in correspondence with a wiring guide path of the wire to space the wire apart from an avoidance target from which contact is to be prevented.

A locking projection may be provided on one of the first body and the second body, and a locking tab configured to engage with the locking projection may be provided on the other of the first body and the second body, such that the entrance may be opened or closed by coupling or separating the locking projection and the locking tab.

The second body may be rotatably provided with respect to the first body via a hinge shaft, and the second body may be rotated in one direction or the other direction to open or close the entrance.

The guide part may include a corrugation tube in which a plurality of corrugations are formed along a longitudinal direction, and the step of deforming the guide part may include bending or deforming the corrugation tube in correspondence with the wiring guide path.

The method may further include a step of providing a support part at an outer end of the guide part, and coupling the support part to an adjacent component element or a neighboring separate wire cover to support the guide part.

The first body may further include a connector accommodation space configured to receive at least a portion of a connector, and the step of accommodating the wire may include receiving the connector connected to the wire in the connector accommodation space.

The wire cover and the operating method thereof according to the present embodiment can stably support and connect a wire while avoiding surrounding component elements or structures within the installation space.

The wire cover and the operating method thereof according to the present embodiment allow for easy and rapid routing of a wire, even along wiring paths having various angles and shapes.

The wire cover and the operating method thereof according to the present embodiment have a simple structure, enabling smooth application and compatibility with wiring paths of various angles and shapes.

The wire cover and the operating method thereof according to the present embodiment can improve the efficiency of wiring operations and reduce manufacturing and labor costs.

The wire cover and the operating method thereof according to the present embodiment can enhance the performance and durability of the wire, the electric component, and the surrounding component elements.

The wire cover and the operating method thereof according to the present embodiment can improve the spatial utilization of a vehicle body or panel.

### BRIEF DESCRIPTION OF THE SEVERAL VIEWS OF THE DRAWINGS

The above and other aspects, features and other advantages of the present disclosure will be more clearly understood from the following detailed description taken in conjunction with the accompanying drawings, in which:

FIG. 1 is a perspective view showing a state in which a wire cover according to the present embodiment is installed.

FIG. 2 is a perspective view showing the wire cover according to the present embodiment.

FIG. 3 is a cross-sectional view showing the wire cover according to the present embodiment.

FIG. 4 is a perspective view showing the wire cover according to the present embodiment, in which the second body is rotated and spaced apart from the first body.

FIG. 5 is a perspective view showing a modified embodiment of the wire cover according to the present disclosure, in which the second body is separated and spaced apart from the first body.

FIG. 6 is a perspective view showing a state in which a wire and a connector enter the accommodation space of the wire cover according to the present embodiment.

FIG. 7 is a perspective view showing a state in which the wire and the connector are accommodated and seated by the wire cover according to the present embodiment.

FIG. 8 is a perspective view showing a state in which the guide part is bent or deformed so that the wire and the wire cover are routed while bypassing an avoidance target according to the present embodiment.

### DETAILED DESCRIPTION

Hereinafter, embodiments of the present disclosure will be described in detail with reference to the accompanying drawings. These embodiments are provided to fully convey the spirit of the present disclosure to those skilled in the art to which the disclosure pertains. The present disclosure is not limited to the embodiments set forth herein and may be embodied in other forms.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

In the drawings, portions irrelevant to the explanation of the disclosure may be omitted for clarity.

As used herein, the term “connected” is intended to have the broadest possible meaning. Specifically, the phrase “A is connected to B” encompasses both a direct connection—where no intervening components or elements are present—and an indirect connection, where one or more intermediate components or elements exist between A and B. In other words, “A is connected to B” includes both direct physical or electrical coupling and indirect coupling through one or more intervening components. Unless explicitly stated otherwise, these terms do not require direct physical or electrical contact. The term “coupled” and “in contact” should be interpreted in the same manner.

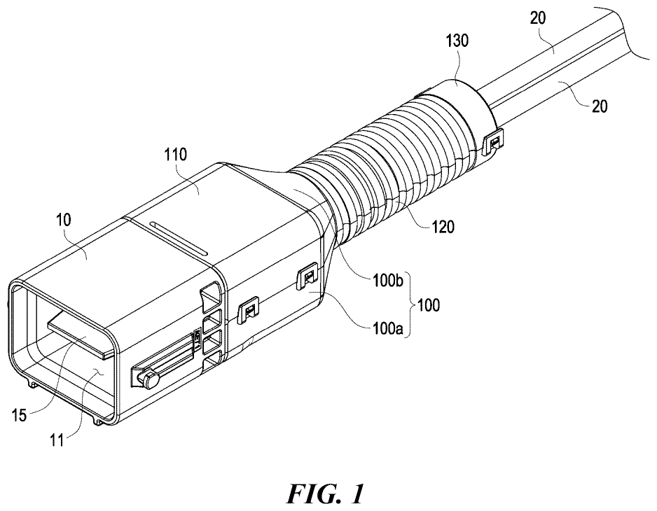

FIG. 1 is a perspective view showing a state in which the wire cover 100 according to the present embodiment is installed, and more specifically, a state in which the connector 10 and the wire 20 are enclosed and supported by the wire cover 100.

Referring to FIG. 1, a connector 10 typically functions as an intermediary that electrically connects an electric component (not shown) and a wire 20, by having one end connected to the electric component and the other end connected to the wire 20. The electric component may transmit power from a battery or transmit electrical signals to a control device or a separate electric component through the connector 10 and the wire 20. To achieve this, the connector 10 may include a terminal 15 configured to contact a connection terminal provided on the electric component. One end of the terminal 15 may be exposed to the outside of the connector housing, while the other end may be connected to the wire 20. In order to ensure secure coupling with the electric component and to protect the terminal 15, a terminal groove 11 may be formed at one end of the connector housing, and the terminal 15 may be positioned inside the terminal groove 11. In addition, a protrusion or groove 12 may be formed on the outer surface of the connector housing to engage with a locking rib 115 of the wire cover 100, which will be described in detail below.

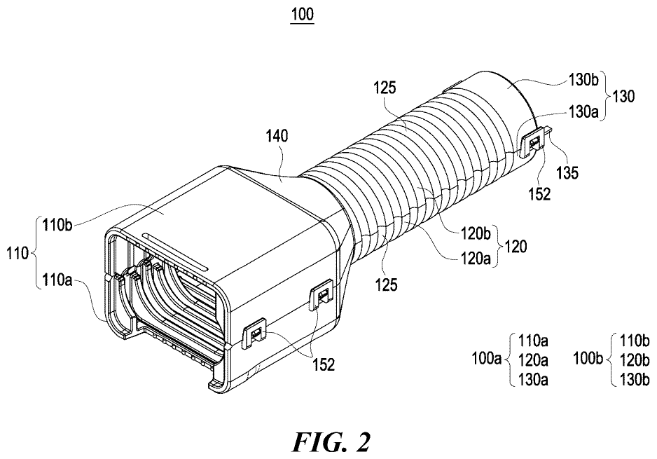

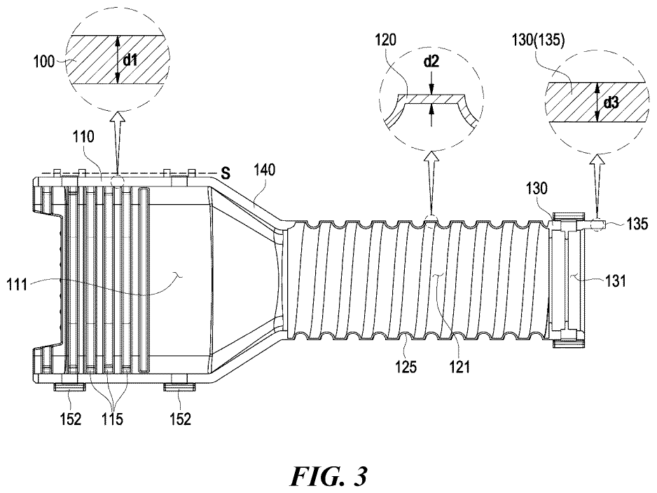

FIG. 2 is a perspective view showing the wire cover 100 according to the present embodiment, and FIG. 3 is a cross-sectional view showing the wire cover 100 according to the present embodiment.

Referring to FIGS. 1 to 3, the wire cover 100 according to the present embodiment is configured to surround and protect the wire 20, and may include a wire cover 100 that guides the wire 20 to be installed and routed along a wiring guide path. The wire 20, which is enclosed by the wire cover 100 and guided in the wiring direction, has one end connected to the connector 10 and the other end connected to a battery or another electric device (not shown).

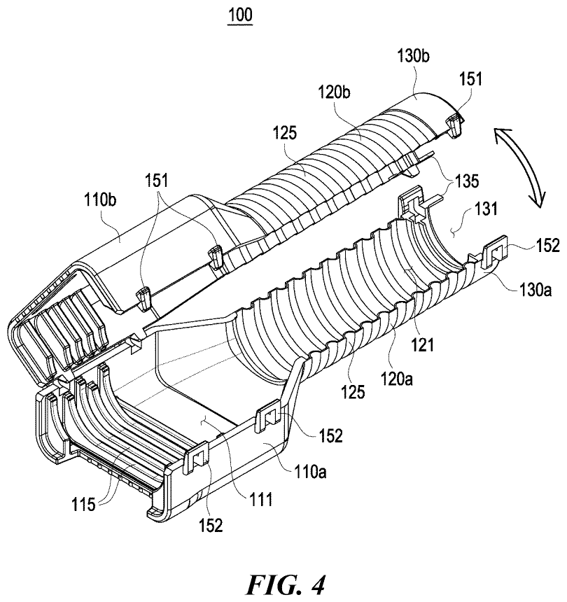

FIG. 4 is a perspective view showing the wire cover 100 according to the present embodiment, in which the second body 100b is shown in a rotated and spaced-apart state from the first body 100a. Referring to FIGS. 2 to 4, the wire cover 100 may include a mounting part 110 configured to be mounted to the connector 10, a guide part 120 extending from the mounting part 110 along a longitudinal direction of the wire 20, and a support part 130 provided at an end of the guide part 120. The wire cover 100 may be formed with a hollow interior so that the connector 10 and the wire 20 can be received and pass through the inside. The mounting part 110, the guide part 120, and the support part 130 may each have an internal accommodation space to allow smooth insertion of the connector 10 and the wire 20 and to enclose and retain them. These parts may be composed of a first body 100a and a second body 100b that are separable and joinable along a direction parallel to the longitudinal direction of the wire 20.

The wire cover 100 may be formed of a material that exhibits rigidity and flexibility depending on its thickness. For example, the wire cover 100 may include a polyamide material that provides metal-like strength when exceeding a certain thickness, while allowing deformation and retention of the deformed state when below that thickness. When the wire cover 100 is made of polyamide, it not only allows adjustment of rigidity and flexibility based on thickness, as described above, but also improves wear resistance against friction and contamination resistance against oil and other foreign substances in contact with surrounding component elements. The mounting part 110, the guide part 120, and the support part 130 of the wire cover 100 may be provided with different thicknesses to achieve appropriate rigidity or flexibility, which will be described in more detail below with reference to FIG. 3.

The first body 100a and the second body 100b of the wire cover 100 may each be formed as an integral structure. Specifically, the mounting part 110a, the guide part 120a, and the support part 130a of the first body 100a may be integrally injection-molded using the same material such as polyamide, and likewise, the mounting part 110b, the guide part 120b, and the support part 130b of the second body 100b may also be integrally injection-molded using the same material as the first body 100a. This allows for reduced manufacturing time and cost of the wire cover 100.

The mounting part 110 is provided on one side of the wire cover 100. The mounting part 110 may be integrally injection-molded using the same material as the guide part 120 and the support part 130, which will be described later. When the first body 100a and the second body 100b are coupled, the mounting part 110 may be formed with a hollow interior, including a connector accommodation space 111 in which at least a portion of the connector 10 is received and seated. The connector accommodation space 111 may be formed in at least one of the mounting part 110a of the first body 100a and the mounting part 110b of the second body 100b. When the first body 100a and the second body 100b are separated or spaced apart from each other, an entrance to the connector accommodation space 111 may be opened in a radial direction with respect to the connector 10. When the first body 100a and the second body 100b are coupled, the connector accommodation space 111 and the entrance may be partitioned or closed from the outside in the radial direction of the connector 10.

Referring to FIG. 3, the mounting part 110 is formed with a certain thickness to provide a level of rigidity sufficient for stable and secure engagement with the connector 10. For this purpose, the thickness d1 of the mounting part 110 may be set to enable reliable coupling with the connector 10, and may be relatively greater than the thickness d2 of the guide part 120, which will be described later. For example, when the wire cover 100 is made of a polyamide material, the thickness d1 of the mounting part 110 may be in a range of about 1.5 T to 2.0 T.

In FIGS. 1 and 2, the opposing or separation surfaces of the first body 100a and the second body 100b of the wire cover 100 are illustrated as being formed near the center in the height direction, such that the height of the first body 100a and the height of the second body 100b are similar, and the connector accommodation spaces 111 of the first body 100a and the second body 100b are formed to have similar volumes by being divided accordingly. However, this is merely one example provided to aid in understanding the present disclosure, and is not limited thereto. For instance, the height of the first body 100a of the wire cover 100 may be relatively greater than that of the second body 100b, such that the connector accommodation space 111 is provided only in the mounting part 110a of the first body 100a, while the second body 100b is configured to partition or close the connector accommodation space 111 and the entrance from the outside. Conversely, the height of the second body 100b may be relatively greater than that of the first body 100a, such that the connector accommodation space 111 is provided only in the mounting part 110b of the second body 100b, and the first body 100a is configured to partition or close the connector accommodation space 111 and the entrance from the outside.

The inner surface of the mounting part 110 may be formed to correspond to the outer surface shape of the connector 10. A locking rib 115 may be provided on the inner surface of the mounting part 110, protruding inwardly or recessed, in order to ensure secure engagement and coupling with the connector 10. For example, when a groove 12 is formed as a locking structure on the outer surface of the connector 10, the locking rib 115 may protrude from the inner surface of the mounting part 110 and be inserted into the groove, thereby coupling the connector 10 and the mounting part 110. Conversely, if a protrusion is formed on the outer surface of the connector 10 as a locking structure, the locking rib 115 may be recessed on the inner surface of the mounting part 110, such that the protrusion is inserted into the locking rib 115, allowing the connector 10 and the mounting part 110 to be joined together. The locking rib 115 of the mounting part 110 and the locking structure of the connector 10 may be provided at multiple positions to ensure stable support and engagement between the connector 10 and the wire cover 100. If necessary, at least one of the locking rib 115 of the mounting part 110 and the locking structure of the connector 10 may be arranged in plurality along the longitudinal direction of the wire cover 100 to adjust the contact area between the connector 10 and the wire cover 100.

The guide part 120 extends from one side of the mounting part 110 along the longitudinal direction of the wire 20. The guide part 120 may be integrally injection-molded using the same material as the mounting part 110 and the support part 130, which will be described later. When the first body 100a and the second body 100b are coupled, the guide part 120 may be formed with a hollow interior and may include a wire accommodation space 121 in which at least one wire 20 is received and seated. The wire accommodation space 121 may be formed in at least one of the guide part 120a on the first body 100a and the guide part 120b on the second body 100b. When the first body 100a and the second body 100b are separated or spaced apart, an entrance to the wire accommodation space 121 may be opened in a radial direction with respect to the wire 20, allowing the wire 20 to enter or exit. When the first body 100a and the second body 100b are coupled, the wire accommodation space 121 and the entrance may be partitioned or closed from the outside in the radial direction of the wire 20.

The guide part 120 is configured to surround and protect the wire 20 while also being deformable and maintainable in accordance with the wiring guide path of the wire 20. In the present embodiment, the term “wiring guide path” of the wire 20 refers to a path that is intended to space the wire 20 apart from and route it around an avoidance target (A), such as a surrounding component element or structure located along the wiring route. The guide part 120 can be bent, deformed, and maintained along the wiring guide path of the wire 20 to prevent the wire 20 from contacting or interfering with the avoidance target (A). By being bendable or deformable in various directions, the guide part 120 enables stable routing of the wire 20 regardless of the installation position or the shape of the wiring path.

The guide part 120 has a shape that enables smooth bending or deformation along the wiring guide path. Specifically, it may include a corrugation tube 125 in which a plurality of corrugations are continuously formed along the longitudinal direction. The corrugation tube 125 may be provided in both the guide part 120a of the first body 100a and the guide part 120b of the second body 100b. The corrugation tube 125 may be formed in a wave shape in which the cross-sectional diameter repeatedly expands and contracts, or in a thread-like shape that extends continuously in the longitudinal direction. With this structure, when the guide part 120 is bent to one side according to the wiring guide path, the corrugation tube 125 is deformed such that the spacing between corrugations decreases on one side and increases on the opposite side, thereby maintaining the deformed shape.

In addition, the guide part 120 may be formed with a thickness d2 that allows it to be smoothly deformed and maintained along the wiring guide path. Referring to FIG. 3, the thickness d2 of the guide part 120 or the corrugation tube 125 may be set to provide flexibility sufficient to enable bending and deformation under external forces such as manipulation by a worker, while still maintaining the deformed state. The thickness d2 may be formed to be relatively smaller than the thickness d1 of the mounting part 110 and the thickness d3 of the support part 130, which will be described later. For example, when the wire cover 100 is made of a polyamide material, the thickness d2 of the guide part 120 or the corrugation tube 125 may be in the range of about 0.6 T to 0.9 T.

Similar to the previously described mounting part 110, the guide part 120 is illustrated in FIGS. 1 and 2 as having the opposing or separation surfaces of the first body 100a and the second body 100b formed near the center in the height direction. Accordingly, the heights of the first body 100a and the second body 100b are configured to be similar, and the wire accommodation spaces 121 of the first body 100a and the second body 100b are divided to have similar volumes. However, this is merely one example provided to facilitate understanding of the present disclosure and is not intended to limit the scope of the disclosure. For example, the height of the first body 100a of the wire cover 100 may be relatively greater than that of the second body 100b, such that the wire accommodation space 121 is formed only in the guide part 120a of the first body 100a, while the second body 100b is configured to partition or close the wire accommodation space 121 and the entrance from the outside. Conversely, the height of the second body 100b may be relatively greater than that of the first body 100a, such that the wire accommodation space 121 is formed only in the guide part 120b of the second body 100b, and the first body 100a is configured to partition or close the wire accommodation space 121 and the entrance from the outside.

A taper member 140 (also referred to as ‘a taper portion 140’) may be interposed between the mounting part 110 and the guide part 120. In general, since the width of the connector 10 and the outer diameter of the wire 20 differ from each other, a difference may occur between the outer width of the mounting part 110, which receives the connector 10, and the outer width of the guide part 120, which receives the wire 20. If a step is formed between the outer surfaces of the mounting part 110 and the guide part 120, the wire cover 100 may frequently become caught on surrounding structures during installation or may interfere or collide with adjacent components. To address this, a taper portion 140 may be provided between the mounting part 110 and the guide part 120, the cross-sectional width of which gradually decreases from the mounting part 110 toward the guide part 120. Due to the inclined outer surface of the taper portion 140, it is possible to suppress the formation of a stepped structure on the outer surface of the wire cover even when the outer widths of the mounting part 110 and the guide part 120 are different. As a result, the wire cover 100 can be smoothly installed in a complex-shaped installation space, such as a vehicle body or panel, while minimizing impact or abrasion between component elements.

The support part 130 is provided at the outer end of the guide part 120. When the first body 100a and the second body 100b are coupled, the support part 130 is formed with a hollow interior, allowing the wire 20, which is received and seated in the guide part 120, to pass through the support part 130. The support part 130 may be integrally injection-molded using the same material as the mounting part 110 and the guide part 120. It may be formed in a ring structure, such that the wire 20 enclosed by the wire cover 100 passes axially through a passing hole 131 formed on the inner side of the ring, and is directed toward the intended wiring path.

The support part 130 may support the guide part 120 on a support target such as a component to which the wire 20 is connected, an adjacent component, or a neighboring separate wire cover 100. This enables the wire 20 and the guide part 120 to be stably supported along the wiring guidance path, and helps maintain the deformed state of the guide part 120. To this end, a support protrusion 135 may be formed to protrude from the support part 130 so as to be at least partially inserted into or caught by the support target. By connecting and supporting the support protrusion 135 of the support part 130 to the support target, the outer end of the guide part 120 can be stably maintained and supported according to the wiring guidance path. As a result, contact or interference between the wire 20 and the avoidance target (A) can be prevented, and the wire 20 can be reliably routed.

The support part 130 may be formed with a predetermined thickness (d3) to have a level of rigidity sufficient to stably couple and support the outer end of the guide part 120. Referring to FIG. 3, the support part 130 may be formed with a thickness (d3) capable of stably protecting the wire 20 by maintaining the inner diameter of the guide part 120 or the support part 130 even when contacting adjacent component elements. Alternatively, the support part 130 may have a thickness (d3) that allows it to be firmly connected and supported by a support target such as a component to be connected, an adjacent component, or a neighboring separate wire cover 100. The thickness (d3) of the support part 130 may be formed relatively greater than the thickness (d2) of the guide part 120 and may be similar to the thickness (d1) of the mounting part 110, which is configured to have a certain level of rigidity. For example, when the wire cover 100 is made of a polyamide material, the thickness (d3) of the support part 130 may be in the range of approximately 1.5 T to 2 T.

Similar to the mounting part 110 and the guide part 120, the support part 130 may also be divided into a support part 130a on the first body 100a and a support part 130b on the second body 100b. The mounting part 110a, the guide part 120a, and the support part 130a of the first body 100a may be integrally formed as a unit, and the mounting part 110b, the guide part 120b, and the support part 130b of the second body 100b may also be integrally formed as a unit. When the first body 100a and the second body 100b are separated or spaced apart from each other, the connector receiving space 111, the wire receiving space 121, and the passing hole 131 may be opened in a radial direction. When the first body 100a and the second body 100b are coupled to each other, the connector receiving space 111, the wire receiving space 121, and the passing hole 131 may be partitioned or closed from the outside in the radial direction.

As described above, the wire cover 100 according to the present embodiment comprises a first body 100a and a second body 100b having opposing or mating surfaces in a direction parallel to the longitudinal direction of the wire 20. The mounting part 110, the guide part 120, and the support part 130 are respectively provided on the first body 100a and the second body 100b. When the first body 100a and the second body 100b are separated and spaced apart from each other, the connector receiving space 111, the wire receiving space 121, and the passing hole 131 are opened so that the connector 10 and the wire 20 can smoothly enter and be accommodated therein. When the first body 100a and the second body 100b are coupled to each other, they can support and cover the connector 10 and the wire 20 on the inner side. In this case, the first body 100a and the second body 100b may be hingedly connected to each other for ease of separation and coupling.

Referring to FIG. 4, the second body 100b may be rotatably provided on the first body 100a via a hinge shaft S. Specifically, the hinge shaft S may be provided between one end of the mounting portion 110a of the first body 100a, where the outer width is the greatest, and one end of the mounting portion 110b of the second body 100b. The arrangement direction of the hinge shaft S may be in a direction parallel to the longitudinal direction of the wire 20. As the first body 100a and the second body 100b rotate relative to each other about an axis parallel to the longitudinal direction of the wire 20, the connector 10 and the wire 20 can enter and be accommodated inside the wire cover 100.

In addition, a locking protrusion 151 may be formed to protrude from one of the opposite ends of the mounting portion 110a of the first body 100a and the mounting portion 110b of the second body 100b, and a locking tab 152 that engages with the locking protrusion 151 may be formed on the other of the opposite ends of the mounting portion 110a of the first body 100a and the mounting portion 110b of the second body 100b. Through this configuration, when the first body 100a and the second body 100b are coupled to each other, the locking protrusion 151 is fastened to the locking tab 152, thereby allowing the first body 100a and the second body 100b to be joined together. At this time, in order to enhance the secure coupling between the first body 100a and the second body 100b, the support member 130 (also referred to as a ‘support portion 130’) may additionally be provided with the locking protrusion 151 and the locking tab 152.

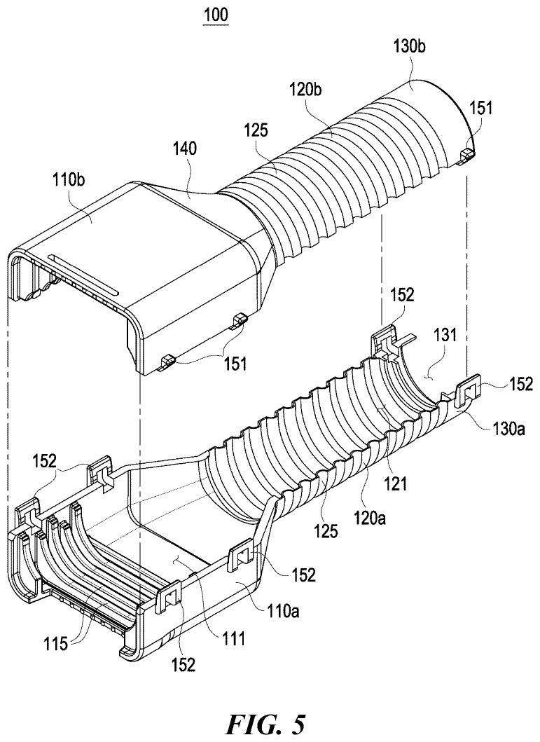

Alternatively, the first body 100a and the second body 100b may be completely separated from each other to facilitate smooth installation of the wire cover 100 depending on the shape of the installation space of the vehicle body or panel. FIG. 5 is a perspective view illustrating a wire cover 100 according to a modified embodiment of the present disclosure. Referring to FIG. 5, the first body 100a and the second body 100b may be separated and spaced apart from each other as independent components without any connecting portion. When the first body 100a and the second body 100b are separated such that the opening surface is oriented in a direction parallel to the longitudinal direction of the wire 20, the connector 10 and the wire 20 can be radially introduced and accommodated within the wire cover 100. In this configuration, a locking protrusion 151 may protrude from one of the first body 100a and the second body 100b, and a locking tab 152 that engages with the locking protrusion 151 may be formed on the other. When the first body 100a and the second body 100b are coupled to each other, the locking protrusion 151 is fastened to the locking tab 152, thereby joining the first body 100a and the second body 100b together. The locking protrusion 151 and the locking tab 152 may be provided in plurality at the mounting portion 110 and the support portion 130, which are formed with a thickness having rigidity, thereby ensuring secure coupling between the first body 100a and the second body 100b.

Hereinafter, a method of operating the wire cover 100 according to the present embodiment will be described.

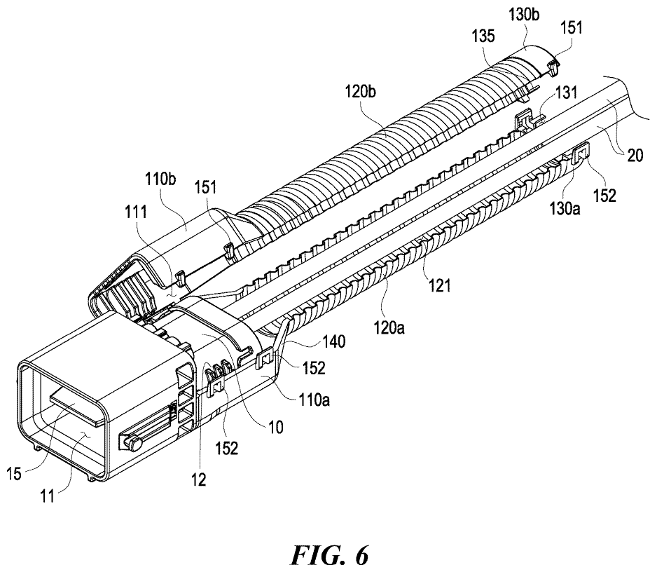

FIG. 6 is a perspective view illustrating a state in which the wire 20 and the connector 10 enter the receiving space of the wire cover 100 according to the present embodiment. Referring to FIG. 6, when it is desired to route the wire 20 for electrical connection of electronic components within an installation space of a vehicle body or panel, the first body 100a and the second body 100b of the wire cover 100 are separated. In the case where the first body 100a and the second body 100b are hinge-connected, the second body 100b is rotated in one direction with respect to the first body 100a, thereby opening the connector entry port and wire entry port of the first body 100a, which serve as an open face or opposing face in the direction parallel to the longitudinal direction of the wire 20. Simultaneously, the connector receiving space 111 of the mounting portion 110, the wire receiving space 121 of the guide portion 120, and the passing hole 131 of the support portion 130 are opened. Then, the connector 10 is inserted and received in the connector receiving space 111 of the mounting portion 110, and the wire 20 connected to the connector 10 is inserted and received in the wire receiving space 121 of the guide portion 120. In addition, the outer portion of the wire 20 extending outward passes through the passing hole 131 of the support portion 130.

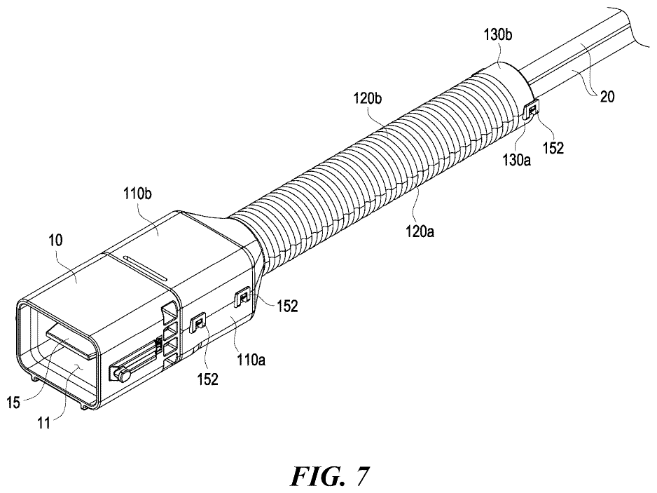

After the connector 10 and the wire 20 are inserted and received in the inner side of the first body 100a, the receiving spaces and entry ports are partitioned or closed off from the outside. FIG. 7 is a perspective view illustrating a state in which the wire 20 and the connector 10 are received and seated by the wire cover 100 according to the present embodiment. Referring to FIG. 7, the first body 100a and the second body 100b are joined to receive and seat the connector 10 inside the wire cover 100 and to enclose the wire 20. As shown in FIG. 4, when the first body 100a and the second body 100b are hinge-connected, the second body 100b is rotated in the opposite direction with respect to the first body 100a, thereby closing the connector entry port and the wire entry port of the first body 100a, and simultaneously closing the connector receiving space 111 of the mounting portion 110, the wire receiving space 121 of the guide portion 120, and the passing hole 131 of the support portion 130. Then, by coupling the fastening protrusion 151 and the fastening tab 152 provided on the first body 100a and the second body 100b, the receiving and seating of the connector 10 and the wire 20 inside the wire cover 100 can be completed.

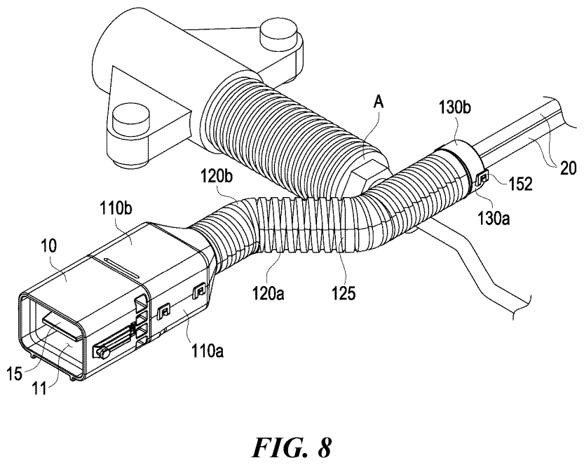

After the connector 10 and at least a portion of the wire 20 are received by the wire cover 100 through the coupling of the first body 100a and the second body 100b, the guide portion 120 is deformed to correspond to the wiring guide path of the wire 20. FIG. 8 is a perspective view illustrating a state in which the guide portion 120 according to the present embodiment is bent or deformed such that the wire 20 and the wire cover 100 are routed to avoid an obstruction (A). Referring to FIG. 8, the wiring path is configured such that the wire 20 is spaced apart from and bypasses the obstruction (A), such as a surrounding component or structure along the wiring route of the wire 20. The guide portion 120 or the corrugation tube 125 is bent or deformed in accordance with the wiring guide path, thereby preventing the wire 20 from contacting or interfering with the obstruction (A). At this time, the guide portion 120 or the corrugation tube 125 maintains the deformed state, thereby suppressing contact or interference between the wire 20 and the obstruction (A) even during operation of the vehicle or equipment. Since the guide portion 120 or the corrugation tube 125 can be bent or deformed in accordance with various wiring paths, smooth wiring work can be performed regardless of the size, shape, or location of the installation space. Furthermore, by applying a wire cover 100 having a single structure to various types of installation spaces, product compatibility can be increased, and thereby, the costs and materials consumed can be reduced.

Optionally, during or after the bending or deformation of the guide portion 120 or the corrugation tube 125, the support portion 130 may be connected or coupled to a surrounding support target so as to support the guide portion 120, thereby more effectively maintaining the deformed state of the guide portion 120 or the corrugation tube 125. For a stable connection between the support portion 130 and the support target, the support protrusion 135 provided on the support portion 130 may be inserted into or fastened to the support target. As a result, the support portion 130 can stably maintain the state in which the wire 20 and the guide portion 120 are spaced apart from the obstruction (A).

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wire cover comprising:
a mounting member configured to be coupled to a connector coupled to an electric component; and
a guide member configured to surround a wire coupled to the electric component via the connector and to extend from the mounting member along a longitudinal direction of a wire,
wherein the mounting member and the guide member are integrally formed or made of the same material,
wherein the guide member has a thickness smaller than that of the mounting member so as to be deformable and capable of maintaining its deformed shape in accordance with a wiring guide path of the wire.

2. The wire cover of claim 1, wherein the guide member includes a corrugation tube having a hollow shape and a plurality of corrugations formed along a longitudinal direction.

3. The wire cover of claim 2, wherein the guide member is made of a polyamide material, and a thickness of the guide member or the corrugation tube is in a range of approximately 0.6 T to 0.9 T.

4. The wire cover of claim 2, further comprising a support member provided at an outer end of the guide member.

5. The wire cover of claim 4, wherein a thickness of the support member is greater than a thickness of the guide member.

6. The wire cover of claim 4, wherein the support member includes a support protrusion that supports the guide member on an adjacent component or a neighboring separate wire cover.

7. The wire cover of claim 2, wherein the mounting member and the guide member respectively comprise a first body and a second body that are separable and joinable in a direction parallel to a longitudinal direction of the wire.

8. The wire cover of claim 7, wherein at least one of the guide member on the first body and the guide member on the second body includes a wire receiving space on an inner side and an inlet that is open on one side to allow the wire to enter the wire receiving space, and the first body and the second body are configured to be joined to close the wire receiving space and the inlet.

9. The wire cover of claim 8, further comprising a fastening protrusion provided on one of the first body and the second body, and a fastening tab provided on the other of the first body and the second body and coupled with the fastening protrusion.

10. The wire cover of claim 8, wherein the second body is rotatably coupled to the first body via a hinge shaft.

11. The wire cover of claim 10, wherein an arrangement direction of the hinge shaft is parallel to a longitudinal direction of the wire.

12. The wire cover of claim 4, wherein the mounting member, the guide member, and the support member are integrally formed or made of the same material.

13. The wire cover of claim 7, wherein at least one of the mounting member on the first body and the mounting member on the second body further includes a connector receiving space configured to receive at least a portion of the connector, and the first body and the second body are configured to be joined to close the connector receiving space and the inlet.

14. The wire cover of claim 13, further comprising at least one fastening rib provided on an inner surface of the mounting member, each fastening rib being configured to be coupled to the connector,
wherein the fastening ribs are arranged in a plurality along a longitudinal direction of the wire.

15. A method of operating a wire cover comprising a first body and a second body, the method comprising:
separating or spacing the second body from the first body to open an inlet formed in the first body;
receiving a wire in a wire receiving space of the first body through the inlet;
joining the second body to the first body to cover the wire and close the inlet; and
deforming a guide member, which is formed to extend along a longitudinal direction of the wire, and which has a smaller thickness than other portions of the wire cover to allow deformation, such that the wire is spaced apart from an avoidance target object to prevent contact therewith, the deformation being performed in correspondence with a wiring guide path of the wire.

16. The method of claim 15, wherein a fastening protrusion is provided on one of the first body and the second body, and a fastening tab that is coupled to the fastening protrusion is provided on the other, and the inlet is opened or closed by coupling or separating the fastening protrusion and the fastening tab.

17. The method of claim 15, wherein the second body is rotatably coupled to the first body via a hinge shaft, and the inlet is opened or closed by rotating the second body in one direction or the other.

18. The method of claim 15, wherein the guide member includes a corrugation tube having a plurality of corrugations formed along a longitudinal direction, and the step of deforming the guide portion includes bending or deforming the corrugation tube in correspondence with the wiring guide path.

19. The method of claim 15, further comprising a support member provided at an outer end of the guide member, and a step of supporting the guide member by joining the support member to an adjacent component or a neighboring separate wire cover.

20. The method of claim 15, wherein the first body further includes a connector receiving space configured to receive at least a portion of a connector, and the step of receiving the wire includes receiving the connector, which is coupled to the wire, in the connector receiving space.
